(19) United States
(12) Patent Application Publication
(10) Pub. No.: US 2024/0369443 A1
(43) Pub. Date: Nov. 7, 2024

(54) METHODS AND SYSTEMS FOR ASSET DATA ANALYSIS

(71) Applicant: Constellation Energy Generation, LLC, Baltimore, MD (US)

(72) Inventor: Teague Maxfield, Green Bay, WI (US)

(21) Appl. No.: 18/654,499

(22) Filed: May 3, 2024

Related U.S. Application Data
(60) Provisional application No. 63/500,142, filed on May 4, 2023.

(51) Int. Cl. G01M 5/00

(52) U.S. Cl. CPC G01M 5/0025

(57) ABSTRACT

Methods, apparatuses, and systems are described for gathering and analyzing measurement data associated with a plurality of assets. One or more parameters may be determined based on the measurement data. An indication may be determined based on the one or more parameters. The indication may be indicative of a recommendation to replace at least one asset, to repair at least one asset, to gather additional measurement data for at least one data.

### CROSS REFERENCE TO RELATED PATENT APPLICATION

This Application claims priority to U.S. Provisional Application No. 63/500,142, filed May 4, 2023, which is herein incorporated by reference in its entirety.

### BACKGROUND

Groundline inspection services concern assessing the structural integrity of wooden utility poles that carry distribution and transmission lines. Legacy methods of inspection typically leverage several subjective techniques, some of which are destructive in nature. They include hitting the pole with a hammer and listening to the sounds returned and drilling into the pole with a large diameter drill bit. However, conventional methods involve non-destructive techniques that generate digitized data and support assessments based on more objective criteria. Multiple tools are available for use, such as sensor-enabled drills that use a needle-sized drill-bit that is paired with an onboard computing device that both controls the behavior of the drill-bit, and also measures and stores the resistance the drill-bit experiences as it penetrates the pole. Other tools that acquire digitized data have also been used. The data gathered during sampling is then used to derive calculated metrics such as remaining wall thickness and remaining strength of the pole. Unfortunately, the data gathered by these tools is often tailored to the collection of data and analysis for a single utility pole. Furthermore, the data collected usually resides in a single device, such as the sensor-enabled drill used for collecting the data. This creates challenges when trying to analyze, compare, and generate reports associated with multiple different data sets associated with more than one utility pole.

### SUMMARY

It is to be understood that both the following general description and the following detailed description are exemplary and explanatory only and are not restrictive. Methods, systems, and apparatuses for improved data gathering for asset analysis are described.

In an embodiment, are methods comprising, determining, by a computing device, one or more identifiers associated with one or more assets, determining, based on the one or more identifiers, measurement data associated with each asset of the one or more assets, determining, based on the measurement data, one or more parameters associated with each asset of the one or more assets, and outputting the one or more parameters associated with each asset of the one or more assets.

In an embodiment, are systems comprising one or more sensor devices, wherein the one or more sensor devices are configured to determine (e.g. obtain) measurement data from one or more assets, wherein each asset of the one or more assets is associated with an identifier of one or more identifiers, associate the measurement data from each asset with each identifier, send the measurement data associated with each identifier of the one or more identifiers, and a computing device in communication with the one or more sensor devices, wherein the computing device is configured to determine one or more identifiers associated with the one or more assets, receive, based on the determined one or more identifiers, the measurement data associated with the one or more assets, determine, based on the measurement data, one or more parameters associated with each asset of the one or more assets, and output the one or more parameters associated with each asset of the one or more assets.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of the present description serve to explain the principles of the apparatuses and systems described herein:

FIG. 1 shows an example system for planning and executing the collection, analysis, and reporting of results associated with measurement data for multiple assets;

FIG. 2 shows an example system for planning and executing the collection, analysis, and reporting of results associated with measurement data for multiple assets;

FIG. 3 shows an example system implementation for gathering the asset data;

FIG. 4 shows an example user interface;

FIG. 5 shows an example user interface;

FIG. 6 shows an example user interface;

FIG. 7 shows a flowchart of an example method for mission and data acquisition planning;

FIG. 8 shows a flowchart of an example method for obtaining and processing asset measurement data; and

FIG. 9 shows a block diagram of an example system and computing device for creating a mission plan to collect and analyze the measurement data.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

Methods, systems, and apparatuses are described herein for the creation of a workflow, or mission plan, to collect and analyze measurement data of multiple assets. The system may comprise one or more user devices and a computing device in communication with one or more sensor devices. The one or more sensor devices may be configured to determine (e.g., obtain) measurement data from one or more assets. The one or more sensor devices may comprise a resistance sensor-enabled drill, an imaging device, a sampling device, an acoustic sensor, or any combination thereof. The sensor device may be hand-held, affixed to a robotic device or aerial vehicle, or deployed into the field near or on the asset(s) of interests. The one or more sensor devices may be programmed to associate each asset with a unique identifier for sending the measurement data associated with each unique identifier to the computing device. The one or more assets may comprise one or more wooden structures, such as utility poles. The computing device may be configured to receive a mission plan of one or more assets for which to obtain measurement data. For example, the computing device may receive the measurement data, from the one or more sensor devices, associated with one or more identifiers of the one or more assets indicated in the mission plan. The mission plan may comprise data indicative of an identification of the measurement data to be collected for each asset of the one or more assets, an order for obtaining the measurement data of each asset, and one or more criteria for processing the measurement data. The order for receiving the measurement data may be based on a priority of the one or more assets. The computing device may be further configured to track a progress of the mission plan based on the remaining assets that need measurement data. The sensor device and/or the computing device may process the measurement data to determine one or more parameters associated with each asset. The one or more parameters may comprise information indicative of one or more of a structural integrity of each asset, potential areas of internal decay of each asset, potential areas of surface decay of each asset, a thickness of each asset, a strength value of each asset, a density value of each asset, a level of resistance to penetration of each asset, or a remaining wall thickness of each asset. The computing device may be further configured to aggregate the measurement data and/or the one or more parameters and output the aggregated data for display. For example, the data may be aggregated according to each identifier of each asset. The computing device may be further configured to output a notification (e.g., indication) based on the one or more parameters. For example, the notification (e.g., indication) may comprise at least one of a recommendation to replace at least one asset of the one or more assets, a recommendation to repair at least one asset of the one or more assets, or an indication that additional measurement data is needed for at least one asset.

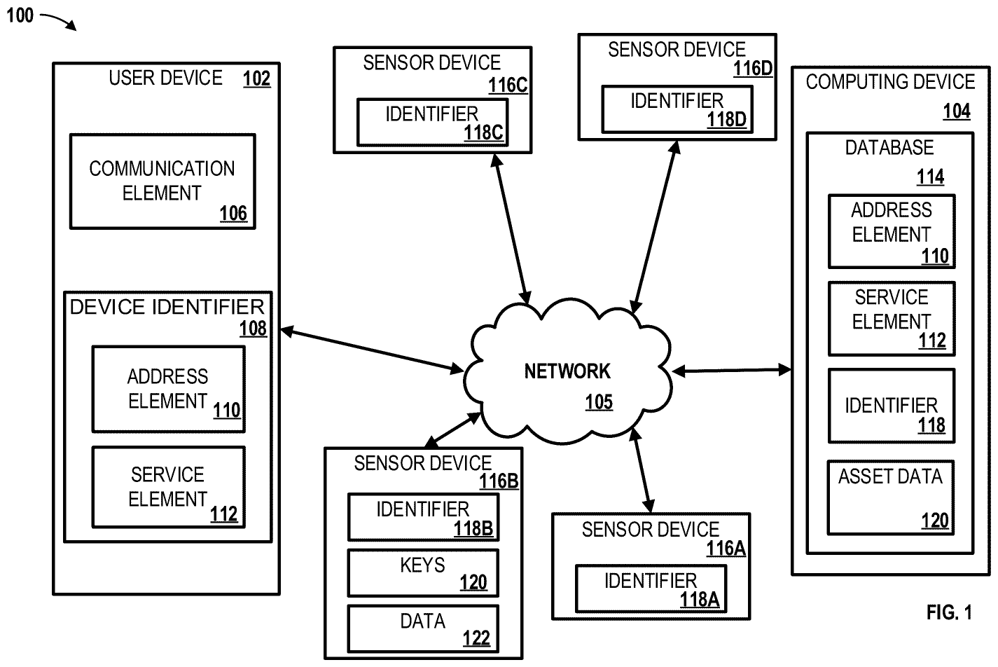

FIG. 1 shows an example system 100 for planning and executing the collection, analysis, and reporting of results associated with measurement data for multiple assets. The system 100 may be configured to provide services, such as network-related services, to one or more user devices. The system may comprise a user device 102 in communication with one or more sensor devices 116A-116D and/or a computing device 104, such as a server, via network 105. The computing device 104 may be disposed locally or remotely relative to the user device 102, the one or more senor devices 116A-116D, and/or the one or more sensor devices 116A-116D. As an example, the user device 102 and the computing device 104 may be in communication via a private and/or public network 105 such as the Internet or a local area network (LAN). Other forms of communications may be used such as wired and wireless telecommunication channels, for example.

The user device 102 may comprise an electronic device such as a computer, a smartphone, a laptop, a tablet, a mobile device, a display device, or other device capable of communicating with the computing device 104. As an example, the user device 102 may comprise a communication element 106 for providing an interface to a user to interact with the user device 102, the sensor devices 116A-116D, and/or the computing device 104. The communication element 106 may be any interface for presenting and/or receiving information to/from the user, such as measurement data and/or one or more parameters associated with the measurement data. An example, the interface may be a communication interface such as a web browser (e.g., Internet Explorer®, Mozilla Firefox®, Google Chrome®, Safari®, or the like). Other software, hardware, and/or interfaces may be used to provide communication between the user and one or more of the user device 102 and the computing device 104. As an example, the communication element 106 may request or query various files from a local source and/or a remote source. As an example, the communication element 106 may transmit data to a local or remote device such as the computing device 104.

The user device 102 may be associated with a user identifier or a device identifier 108. As an example, the device identifier 108 may be any identifier, token, character, string, or the like, for differentiating one user or user device (e.g., user device 102) from another user or user device. In an example, the device identifier 108 may identify a user or user device as belonging to a particular class of users or user devices. As an example, the device identifier 108 may comprise information relating to the user device 102 such as a manufacturer, a model or type of device, a service provider associated with the user device 102, a state of the user device 102, a locator, and/or a label or classifier. Other information may be represented by the device identifier 108.

The device identifier 108 may comprise an address element 110 and a service element 112. In an example, the address element 110 can comprise or provide an internet protocol (IP) address, a network address, a media access control (MAC) address, international mobile equipment identity (IMEI) number, international portable equipment identity (IPEI) number, an Internet address, or the like. As an example, the address element 110 can be relied upon to establish a communication session between the user device 102 and the computing device 104 or other devices and/or networks. As an example, the address element 110 can be used as an identifier or locator of the user device 102. In an example, the address element 110 can be persistent for a particular network.

The service element 112 may comprise an identification of a service provider associated with the user device 102, with the class of user device 102, and/or with a particular network 105 with which the user device 102 is currently accessing services associated with the service provider. The class of the user device 102 may be related to a type of device, capability of device, type of service being provided, and/or a level of service (e.g., business class, service tier, service package, etc.). As an example, the service element 112 may comprise information relating to or provided by a communication service provider (e.g., Internet service provider) that is providing or enabling data flow such as communication services to the user device 102. As an example, the service element 112 may comprise information relating to a preferred service provider for one or more particular services relating to the user device 102. In an example, the address element 110 can be used to identify or retrieve data from the service element 112, or vice versa. As an example, one or more of the address element 110 and the service element 112 may be stored remotely from the user device 102 and retrieved by one or more devices such as the user device 102 and the computing device 104. Other information may be represented by the service element 112.

The user device 102 may be configured to create and maintain a list of device identifiers of devices connected to the same network 105, such as sensor devices 116A-116D. The sensor devices 116A-116D may be configured to determine (e.g., obtain) measurement data associated with one or more assets. The user device 102 may be configured to create a mission plan for receiving the measurement data from the sensor devices 116A-116D. For example, the mission plan may comprise data indicative of an identification of the measurement data to be collected for each asset of the one or more assets, an order for determining (e.g., obtaining) the measurement data of each asset, and one or more criteria for processing the measurement data. The order of receiving the measurement data of each asset of the one or more assets may be based on a priority of each asset of the one or more assets. The one or more criteria may comprise one or more of one or more parameters to be determined from the measurement data, one or more algorithms for analyzing the measurement data, or one or more thresholds associated with the measurement data. In an example, the one or more thresholds may be associated with pass/fail thresholds for the one or more parameters determined from the measurement data. For example, the one or more thresholds may be associated with one or more pass/fail thresholds associated with the measurement data and/or the one or more parameters. In an example, the user device 102 may be configured to pass elements of the mission plan to the one or more sensor devices 116A-116D such as asset name/identifier and targeted data storage location/name, such as the computing device 104. In an example, the user device 102 may track the progress of the mission plan such as by determining which assets still need measurement data to be acquired.

In an example, the user device 102 may comprise two or more user devices such a first user device and a second user device. The first user device may comprise a small portable device such as a mobile device, a tablet, a smartphone, etc. The second device may comprise a laptop computer. The first user device and the second user device may be configured to communicate with each other via one or more communication methods such as wireless communication (e.g., Wi-Fi, Bluetooth, Near Field Communication (NFC), the Internet, etc.), wired communication (e.g., USB, HDMI, RS-232, etc.), or a secure digital (SD) card. In an example, one user device may be configured to act as a companion device to the other user device. For example, one of the user devices may be configured to implement the mission plan and collect the measurement data from the sensor devices 116A-116D and output the measurement data to the other user device for further processing. In an example, the other user device may further transmit the processed data (e.g., the determined one or more parameters of the measurement data of each asset) to the computing device 104 for further processing and aggregation.

In an example, the user device 102 may comprise one or more user devices that include one or more sensor devices 116A-116D. For example, the one or more user devices may include one or more imaging devices for capturing images of the one or more assets. The user devices 102 may capture images of the assets as indicated in the mission plan and further process the captured images to determine one or more parameters of the one or more assets based on the captured images. In an example, the user devices 102 may output the one or more images (e.g., measurement data) to the computing device 104 for further processing. In an example, the user devices 102 may output the one or more images (e.g., measurement data) to a second user device for further processing and the second user device may output the processed data to the computing device 104 for further processing and aggregation.

The user device 102 may be configured to associate an identifier to each asset and send the identifiers to the sensor devices 116A-116D and/or to the computing device 104. The sensor devices 116A-116D may use these identifiers for collecting and aggregating the measurement data according to the identifiers and sending the aggregated data to the user device 102 and/or the computing device 104 for further processing and/or aggregation. In an example, the user device 102 may include the identifiers of each asset in the measurement data of each asset. In an example, the user device 102 may include the identifiers of each asset with the one or more parameters of each asset.

The user device 102 may be configured to analyze and process the measurement data in order to determine one or more parameters associated with each asset. In an example, the sensor devices 116A-116D may be configured to process the measurement data to determine one or more parameters associated with each asset and send the one or more parameters to the user device 102 for further processing. The assets may comprise wooden structures, or poles, and the one or more parameters may comprise information indicative of one or more of a structural integrity of each asset, potential areas of internal decay of each asset, potential areas of surface decay of each asset, a thickness of each asset, a strength value of each asset, a density value of each asset, a level of resistance to penetration of each asset, or a remaining wall thickness of each asset. The user device 102 may be configured to display the measurement data and/or the one or more parameters to the user. In an example, the user device 102 may be configured to present a notification to the user, wherein the notification may comprise at least one of a recommendation to replace at least one asset of the one or more assets, a recommendation to repair at least one asset of the one or more assets, or an indication that additional measurement data is needed for at least one asset. For example, the notification may be output to the user based on the measurement data and/or the one or more parameters satisfying the one or more thresholds. For example, the measurement data and/or the one or more parameters satisfying the one or more thresholds may indicate that the measurement data and/or the one or more parameters do not meet one or more criteria, and thus, indicating that one or more assets need to be replaced, need to be repaired, or require additional measurement data. For example, the notification may be based on whether the measurement data and/or the one or more parameters satisfy one or more fail thresholds or do not satisfy one or more pass thresholds.

The user device 102 may be configured to perform quality analysis on the measurement data by combining multiple measurements into asset-level summary assessments and perform additional quality assessment checks to determine overall inconsistences among each asset individually or one or more groups of assets. For example, the user device 102 may be configured to process large volumes of data, such as resistance graphs associated with the assets, and associate the data to asset records and encode the data with metadata (e.g., asset identifier) to further support asset association. For example, the user device 102, may utilize processes and templates to format and summarize the data, tools to support review and auditing of the data, and tools configured to support visualization of the aggregated results/data. In an example, the user device 102 may be configured to send the mission plan to the computing device 104, wherein the computing device 104 may be configured to receive, process, aggregate, and store the measurement data and determine one or more parameters associated with the assets based on the received mission plan. The computing device 104 may then send the processed and aggregated data to the user device 102 to be displayed to the user.

The computing device 104 may comprise a server for communicating with the user device 102. As an example, the computing device 104 may communicate with the user device 102 for providing data and/or services. As an example, the computing device 104 may provide services, such as network (e.g., Internet) connectivity, network printing, data management (e.g., data server), data storage, broadband services, or other network-related services. In an example, the computing device 104 may allow the user device 102 to interact with remote resources, such as data, devices, and files. As an example, the computing device 104 may be configured as (or disposed at) a central location (e.g., a processing facility), which may receive data (e.g., data, input programming) from multiple sources, such as the sensor devices 116A-116D. The computing device 104 may process the data from the multiple sources and distribute the data to the user (e.g., user device 102) locations via a distribution system.

The computing device 104 may be configured to manage the communication between the user device 102 and/or the sensor devices 116A-116D and a database 114 for sending and receiving data therebetween. As an example, the database 114 may store a plurality of files (e.g., sensor data), data identifiers or records, or other information. As an example, the user device 102 may request and/or retrieve a file from the database 114. In an example, the database 114 may store information relating to the user device 102 such as the address element 110 and/or the service element 112. As an example, the computing device 104 may obtain the device identifier 108 from the user device 102 and retrieve information from the database 114 such as the address element 110 and/or the service elements 112. As an example, the computing device 104 may obtain the address element 110 from the user device 102 and may retrieve the service element 112 from the database 114, or vice versa. Any information may be stored in and retrieved from the database 114. For example, the database 114 may store asset data 120 associated with the measurement data and/or the one or more parameters. The database 114 may be disposed remotely from the computing device 104 and accessed via direct or indirect connection. The database 114 may be integrated with the computing device 104 or some other device or system.

The computing device 104 may be configured to create and implement the mission plan. The computing device 104 may be configured to associate the identifiers for each asset and send the identifiers to the sensor devices 116A-116D and/or the user device 102. The sensor devices 116A-116D may use these identifiers for collecting and aggregating the measurement data according to the identifiers and send the aggregated data to the user device 102. The computing device 104 may be configured to analyze and process the measurement data in order to determine one or more parameters associated with the assets. In an example, the sensor devices 116A-116D may be configured to process the measurement data to determine one or more parameters associated with each asset and send the one or more parameters to the computing device 104 for further processing. The assets may comprise wooden structures, or poles, and the one or more parameters may comprise information indicative of one or more of a structural integrity of each asset, potential areas of internal decay of each asset, potential areas of surface decay of each asset, a thickness of each asset, a strength value of each asset, a density value of each asset, a level of resistance to penetration of each asset, or a remaining wall thickness of each asset. The computing device 104 may be configured to display the measurement data and the one or more parameters to the user. For example, the computing device 104 may be configured to present a notification to the user or output the notification to the user device 102, wherein the notification may comprise at least one of a recommendation to replace at least one asset of the one or more assets, a recommendation to repair at least one asset of the one or more assets, or an indication that additional data is needed for at least one asset. For example, the computing device 104 may be configured to determine whether the measurement data and/or the one or more parameters satisfy one or more pass/fail thresholds. The computing device 104 may present the notification to the user, or output the notification to the user device 102, based on the measurement data and/or the one or more parameters satisfying one or more fail thresholds or not satisfying one or more pass thresholds. In an example, the computing device 104 may be configured to send the notification to the user device 102 to be displayed to the user. In an example, the computing device 104 may be configured to pass elements of the mission plan to the one or more sensor devices 116A-116D such as asset name/identifier and targeted data storage location/name. In an example, the computing device 104 may track the progress of the mission plan, such as determining which assets still need measurement data to be acquired. In an example, the computing device 104 may perform quality assessment checks on the measurement data by combining, or aggregating, multiple measurements into asset-level summary assessments and performing additional quality assessment checks to determine overall inconsistences among each asset individually or one or more groups of assets. The computing device 104 may be configured to process large volumes of data, such as resistance graphs associated with the assets, and associate the data to asset records and encode the data with metadata (e.g., asset identifier) to further support asset association. For example, the computing device 104, may utilize processes and templates to format and summarize the data, tools to support review and auditing of the data, and tools configured to support visualization of the aggregated results/data. As an example, the computing device 104 may be configured to send the processed and aggregated data to the user device 102 to be displayed to the user. As an example, the computing device 104 my use a cloud computing, distributed computing, or client server computing technique for receiving, processing, and aggregating the measurement data and sending the measurement data to the user device 102.

One or more sensor devices 116A-116D may be in communication with a network, such as the network 105. The sensor devices 116A-116D may comprise one or more of a resistance sensor-enabled drill, an imaging device, a sampling device, an acoustic sensor, or any combination thereof. In an example, the sensor device may be hand-held, affixed to a robotic device or aerial vehicle, or deployed into the field near or on the asset(s) of interest, for inspecting and gathering measurement data of the one or more assets. The sensor devices 116A-116D may be configured to receive measurement data associated with one or more assets. The sensor devices 116A-116D may be configured to receive identifiers associated with each asset, wherein the sensor devices 116A-116D may use the identifiers for collecting and aggregating the measurement data according to the identifiers and sending the aggregated data to the user device 102 and/or the computing device 104. In an example, the sensor devices 116A-116D may be configured to receive elements of the mission plan from the user device 102, or the computing device 104, such as asset name/identifier and targeted data storage location/name, such as the user device 102, or the computing device 104. In an example, the sensor devices 116A-116D may be configured to send the measurement data to the user device 102, or the computing device 104, wherein either device may process the measurement data to determine one or more parameters associated with the assets. For example, image data from the one or more image sensors may be sent to the user device 102, or the computing device 104, wherein either device may perform image analytics of the captured images to determine one or more parameters associated with the asset of the captured image. In an example, the sensor devices 116A-116D may be configured to process the measurement data, such as perform image analytics of captured images, for example, to determine one or more parameters associated with an asset. The sensor devices 116A-116D may be configured to send the one or more parameters to the user device 102, or the computing device 104, for further processing.

One or more of the sensor devices 116A-116D may comprise a device identifier 118A-118D. As an example, one or more device identifiers may be related to an Internet Protocol (IP) Address (e.g., IPV4/IPV6) or a media access control address (MAC address) or the like. As an example, one or more of the device identifiers 118A-118D may be a unique identifier for facilitating communications on the physical network segment. In an example, each of the sensor devices 116A-116D may comprise a distinct device identifier 118A-118D. As an example, the device identifiers 118A-118D may be associated with a physical location of the sensor devices 116A-116D.

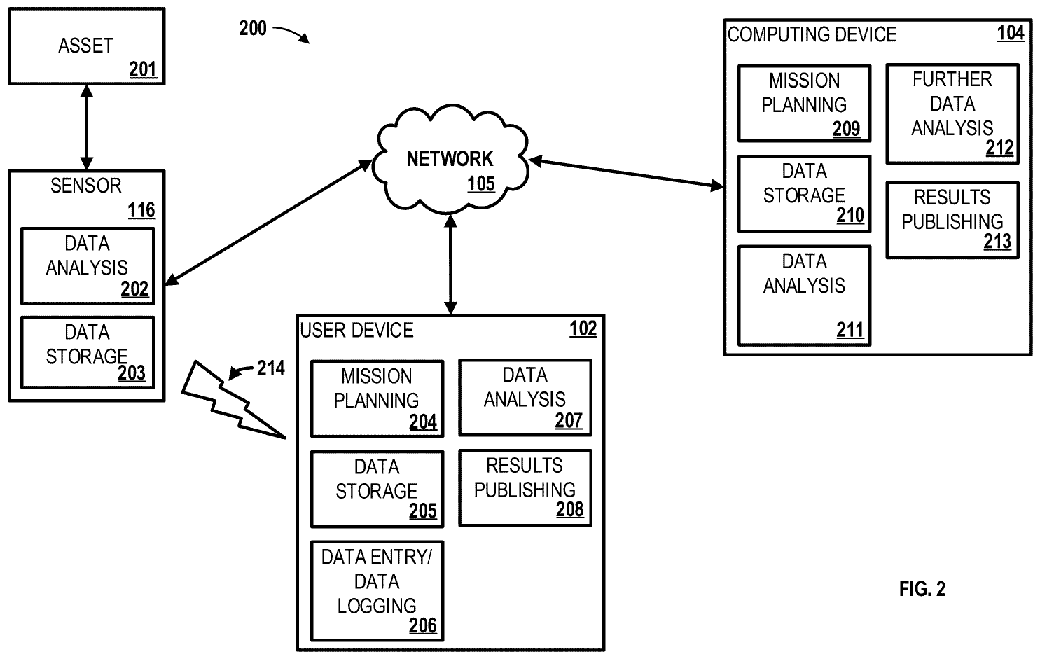

FIG. 2 shows an example system for planning and executing the collection, analysis, and reporting of results associated with measurement data for multiple assets. For example, one or more sensor devices 116 may be configured to determine (e.g., receive, obtain, etc.) measurement data associated with one or more assets 201. The sensor devices 116 may comprise a data analysis component 202 for processing the measurement data and a data storage component 203 for storing the processed measurement data and/or the pre-processed measurement data associated with the assets 201. For example, the data analysis component 202 may be configured to perform limited data analysis on the measurement data to prepare the measurement data for further processing by the user device 102 and/or the computing device 104. For example, the data analysis component 202 may be configured to aggregate the measurement data based on each asset 201. For example, each asset 201 may be associated with an identifier, wherein the data analysis component 202 may be configured to associate each identifier of each asset 201 with the measurement data of each asset 201. In an example, the sensor devices 116 may be configured to process the measurement data to determine one or more parameters associated with each asset 201. The sensor devices 116 may be configured to send the one or more parameters to the user device 102 and/or the computing device 104. The sensor devices 116 and the user device 102 may be configured to communicate with each other via one or more communication methods 214 such as wireless communication (e.g., Wi-Fi, Bluetooth, Near Field Communication (NFC), etc.), wired communication (e.g., USB, HDMI, RS-232, etc.), or a secure digital (SD) card. In an example, the sensor device 116 may be configured to communicate with the computing device 104 and/or the user device 102 via a network 105 (e.g., the Internet, LAN, WAN, etc.).

The user device 102 may comprise a mission planning component 204, a data storage component 205, a data entry/data logging component 206, a data analysis component 207, and a results publishing component 208. In an example, the functions associated with the mission planning component 204, the data storage component 205, the data entry/data logging component 206, the data analysis component 207, and the results publishing component 208 may be distributed across a plurality of user devices 102 or consolidated into a single user device 102. The mission planning component 204 may be configured to generate and maintain a mission plan for determining one or more identifiers associated with one or more assets for which to determine (e.g., obtain) measurement data. For example, the mission plan may comprise data indicative of an identification of the measurement data to be collected for each asset 201, an order for obtaining the measurement data of each asset 201, and one or more criteria for processing the measurement data. For example, the mission planning component 204 may be configured to generate and maintain a mission plan associated with one or more assets or a group of assets associated with a geographical region. In an example, the mission plan may be associated with a designated/specific inspection project. The one or more parameters may comprise information indicative of one or more of a structural integrity of each asset, potential areas of internal decay of each asset, a thickness of each asset, a strength value of each asset, a density value of each asset, a level of resistance to penetration of each asset, or a remaining wall thickness of each asset. The order of receiving the measurement data of each asset of the one or more assets may be based on a priority of each asset of the one or more assets. The one or more criteria may comprise one or more of one or more parameters to be determined from the measurement data, one or more algorithms for analyzing the measurement data, or one or more thresholds associated with the measurement data. For example, the one or more thresholds may be associated with one or more pass/fail thresholds associated with the measurement data.

The data storage component 205 may be configured to store the measurement data and/or the processed measurement data. For example, the user device 102 may be configured to receive the measurement data and/or the processed measurement data from the sensor devices 116 and store the measurement data and/or the processed measurement data in the data storage component 205.

The data entry/data logging component 206 may be configured to associate identifiers for each asset 201 with the measurement data received for each asset 201. For example, the data entry/data logging component 206 may be configured to aggregate the measurement data based on the identifiers of each asset 201. In an example, the data entry/data logging component 206 may be configured to track a progress of the mission plan based on the remaining assets 201 that still need measurement data.

The data analysis component 207 may be configured to process the measurement data based on the mission plan. For example, the data analysis component 207 may be configured to determine the one or more parameters from the measurement data of each asset 201 as specified in the mission plan. In an example, the data analysis component 207 may be configured to aggregate the one or more parameters based on the identifiers of each asset 201. In an example, the data analysis component 207 may be configured to perform quality analysis on the measurement data by combining multiple measurements into asset-level summary assessments and perform additional quality assessment checks to determine overall inconsistences among each asset individually or one or more groups of assets. For example, the data analysis component 207 may be configured to process large volumes of data, such as resistance graphs associated with the assets, and associate the data to asset records and encode the data with metadata (e.g., asset identifier) to further support asset association. In an example, the user devices 102 may receive the one or more parameters of each asset 201 from the sensor devices 116, wherein the sensor devices 116 may be configured to process the measurement data to determine the one or more parameters of each asset 201.

The results publishing component 208 may be configured to output the results of the data analysis of the measurement data. In an example, the results publishing component 208 may be configured to cause the user device 102 to display the one or more parameters and/or the measurement data. For example, the results publishing component 208 may utilize processes and templates to format and summarize the data, tools to support review and auditing of the data, and tools configured to support visualization of the aggregated results/data. In an example, the results publishing component 208 may be configured to output a notification associated with the one or more parameters, wherein the notification may comprise at least one of a recommendation to replace at least one asset 201, a recommendation to repair at least one asset 201, or an indication that additional data is needed for at least one asset 201.

In an example, the user device 102 may be configured to pass elements of the mission plan to the computing device 104. For example, the computing device 104 may comprise a server in communication with the user device 102. For example, the computing device 104 may comprise a mission planning component 209, a data storage component 210, a data analysis component 211, a further data analysis component 212, and a results publishing component 213. The mission planning component 209, the data storage component 210, the data analysis component 211, and the results publishing component 213 of the computing device 104 may perform similar functions as the mission planning component 204, the data storage component 205, the data analysis component 207, and the results publishing component 208 of the user device 102, respectively. For example, the computing device 104 may receive the measurement data from the sensor devices 116 via the network 105 and evaluate, filter, process, and aggregate the measurement data based on the mission plan determined via the mission planning component 209. In an example, the computing device 104 may receive the one or more parameters of each asset 201 from the sensor devices 116, wherein the sensor devices 116 may be configured to process the measurement data to determine the one or more parameters of each asset 201.

In an example, the computing device 104 may comprise a centralized platform (e.g., server in a regional or central office), wherein the mission planning component 209 may be configured to generate and maintain a mission plan regarding a plurality of user devices 102 in communication with a plurality of sensor devices 116 that are configured to collect and analyze measurement data associated with one or more groups of assets associated with one or more geographical regions. In an example, the data analysis component 211 may be configured to further process the measurement data and/or the one or more parameters of the measurement data and aggregate the measurement data and/or the one or more parameters based on the one or more groups of assets associated with the one or more geographical regions. For example, the data analysis component 211 may be configured to perform advanced data analysis functions for processing the measurement data and/or the one or more parameters. For example, the data analysis component 211 may be configured to determine data trends or additional information based on one or more groups of assets of one or more geographical regions. The further data analysis component 212 may be configured to provide an interface to other data analysis platforms, such as application programming interfaces (API's), advanced machine learning models, other data exchange solutions, and the like. For example, the further data analysis component 212 may be configured to utilize the other data analysis platforms for further processing the measurement data and/or the one or more parameters. The results publishing component 213 may utilize processes, templates, and tools to format and aggregate the data based on one or more groups of assets associated with the one or more geographical regions. For example, the results publishing component 213 may be configured to output (e.g., present) the data to one or more end-users (e.g., via such data extracts as CSV, XML, API's, web-based reporting portals, interfaces, other data visualization and reporting engines/dashboards, etc.).

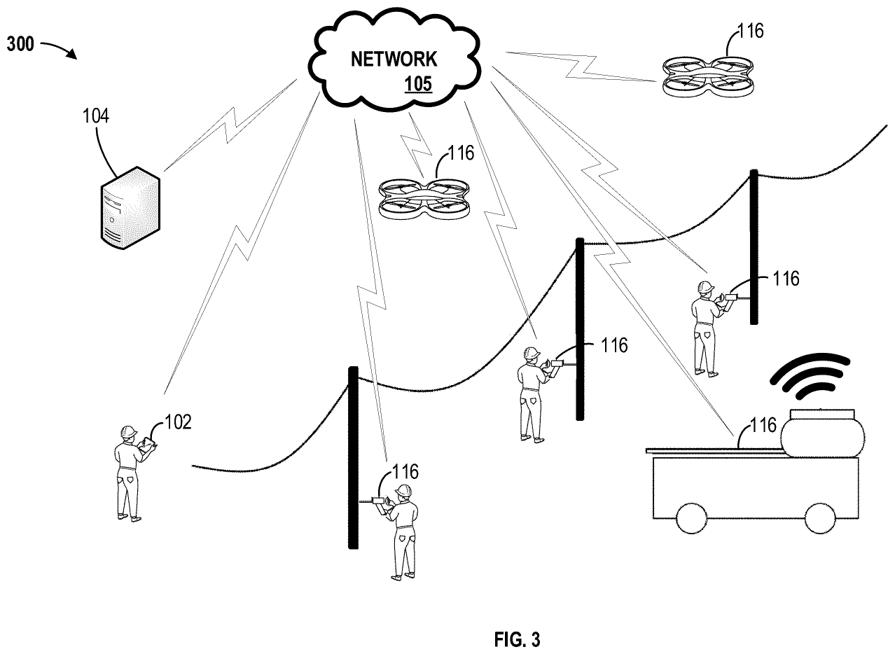

FIG. 3 shows an example system implementation for gathering the asset data. A user may create a mission plan, via the user device 102 or computing device 104, designating one or more assets for which to receive measurement data. The assets may comprise wooden structures, or utility poles. The mission plan may be sent to the user device 102, computing device 104 and/or the one or more sensor devices 116 via network 105. As shown in FIG. 3, the sensor devices may comprise one or more of a resistance sensor-enabled drill, an imaging device, a sampling device, an acoustic sensor, or any combination thereof. In an example, the sensor device may be affixed to an aerial vehicle, as shown in FIG. 3. The mission plan may identify the identifiers of each asset that needs measurement data. The sensor devices 116 may associate each asset with an identifier and send the measurement data associated with each identifier to the user device 102 and/or the computing device 104, via the network 105. In an example, the user device 102 may be configured to receive and process the measurement data and display the processed data to the user. For example, the user device 102 may be configured to support the generation of a large volume of data, such as resistance graphs, and associate the graphs to the asset records and encode the data with metadata (i.e., asset identifiers) to further support asset association. The user device 102 may be configured to use data processing algorithms that generate asset-level summaries based on the received measurement data. The algorithms may provide quality assessment checks of the measurement data by combining multiple measurements into the asset-level summary assessments and performing additional quality assessment checks to determine overall data inconsistencies of each asset or one or more groups of assets. The user device 102 may use further utilize processes to format and summarize the measurement data, tools to support the review and auditing of the measurement data, and tools configured to support the visualization of the aggregated results. In an example, the user device 102 may process the measurement data to determine one or more parameters of each asset and output a notification based on the one or more parameters. For example, the notification may comprise at least one of a recommendation to replace at least one asset of the one or more assets, a recommendation to repair at least one asset of the one or more assets, or an indication that additional data is needed for at least one asset. In an example, the computing device 104 may receive, process, and aggregate the measurement data. For example, after processing and aggregating the measurement data, the computing device 104 may send the processed data to the user device 102, via the network 105, for display to the user. In an example, the sensor devices 116 may be configured to process the measurement data to determine one or more parameters associated with each asset and send the one or more parameters to the user device 102 and/or the computing device 104.

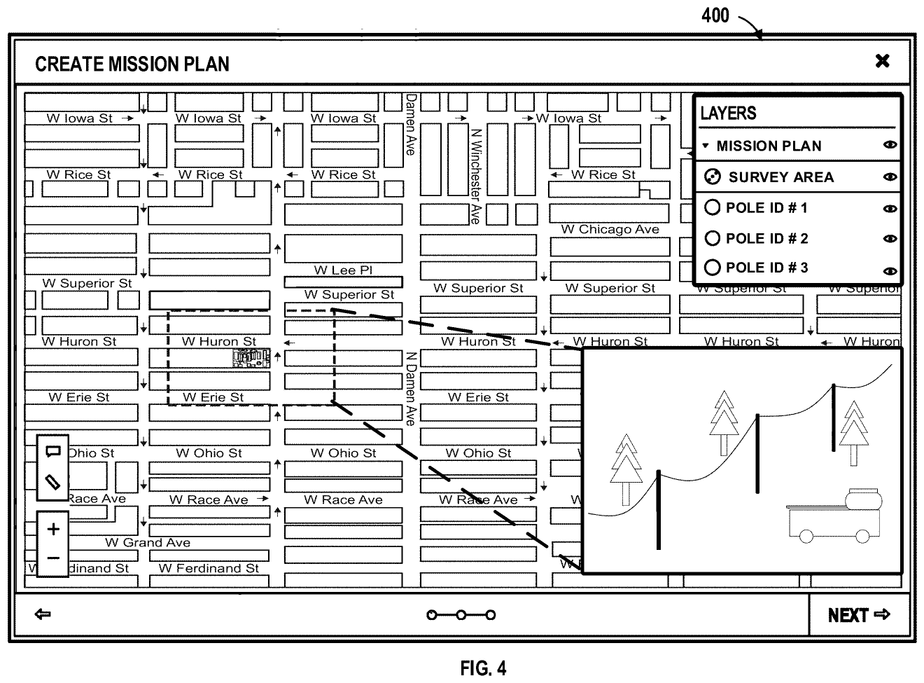

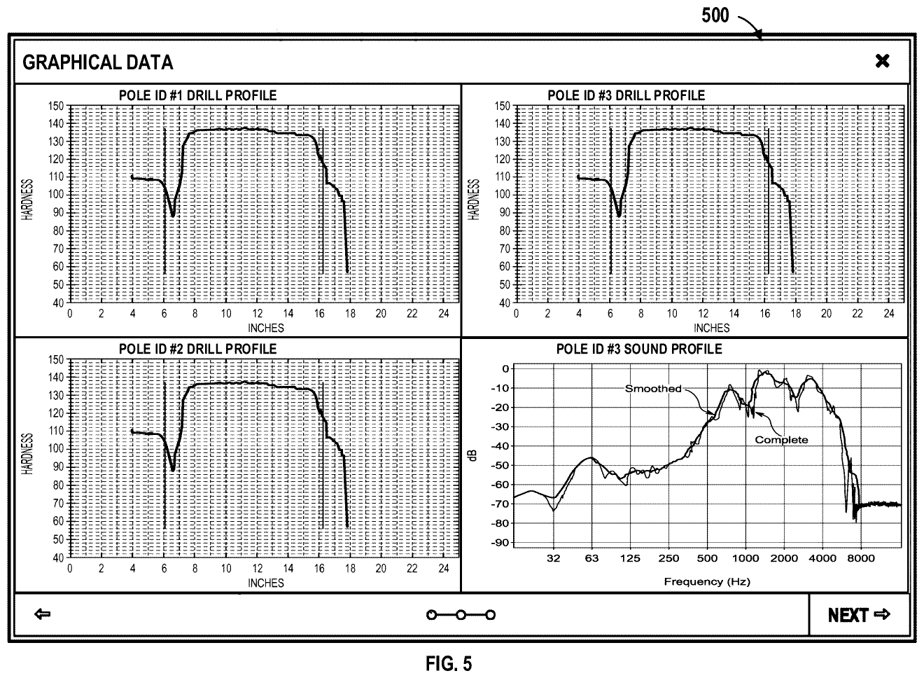

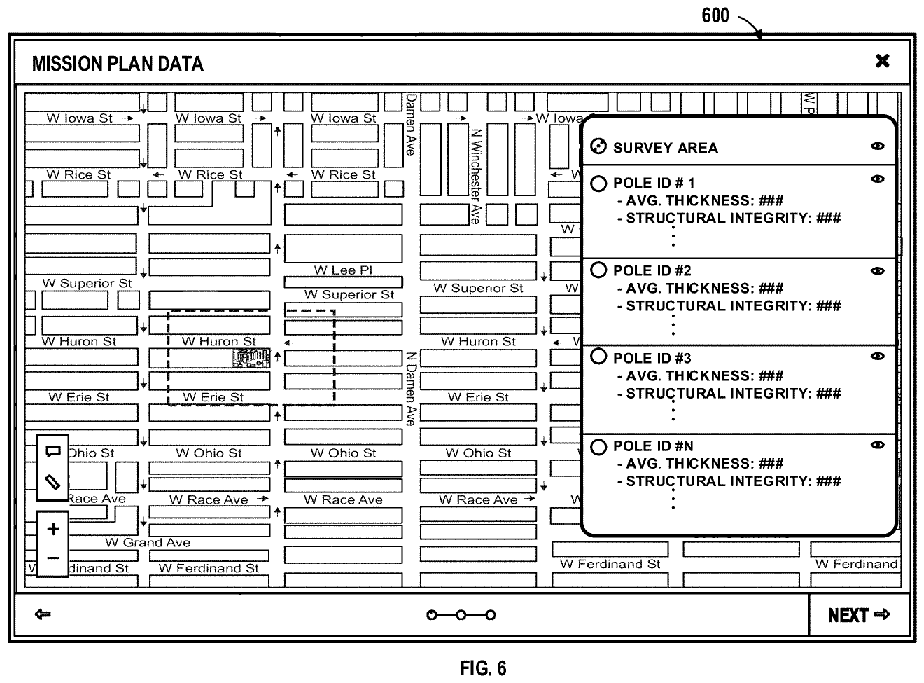

FIGS. 4-6 show examples of a user interface for creating the mission plans and outputting the aggregated results/data. The user interface may be implemented by a display of the user device 102 or the computing device 104. For example, FIG. 4 shows an example user interface for initiating the creation of the mission plan. The user may indicate a survey area in a drop-down menu and select the desired assets for which the user wishes to receive measurement data. In FIG. 4, the user is presented with options to select assets 1, 2, and/or 3. In an example, the user may designate a survey area on a map comprising the assets for which to receive the measurement data. In an example, the user may designate a plurality of survey areas comprising one or more groups of assets for which to receive the measurement data. The user interface may be configured to provide a zoomed-in overlay of the designated area, wherein the user may select the desired assets displayed in the overlay. FIG. 5 shows an example user interface displaying side-by-side results of the aggregated measurement data. This allows for side-by-side comparisons of the aggregated results for a further visual analysis by the user. In an example, the user interface may display the image data received from one or more of the image sensors. For example, the user interface may show the image data in a side-by-side view, similar to the graphs shown in FIG. 5, to allow further visual analysis by the user. FIG. 6 shows an example user interface displaying the aggregated results in an overlay. For example, the results may be displayed to the user according to each asset identifier. The data may include information indicative of one or more of a structural integrity of each asset, potential areas of internal decay of each asset, potential areas of surface decay of each asset, a thickness of each asset, a strength value of each asset, a density value of each asset, a level of resistance to penetration of each asset, or a remaining wall thickness of each asset.

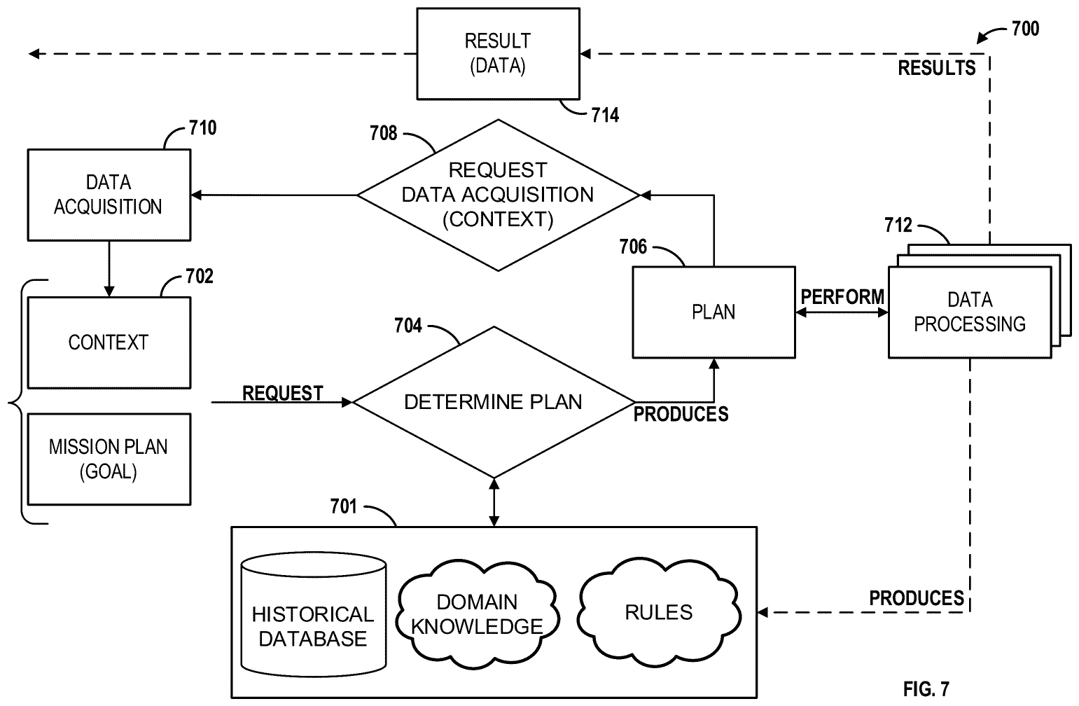

FIG. 7 shows a flowchart of an example mission and data acquisition planning method 700. Method 700 may be implemented by the user device 102, the computing device 104, or any combination thereof. At 702, a user may utilize the user interface to create a mission plan indicating specific assets for which to receive measurement data. The mission plan may comprise user information for acquisition, processing, and/or output of the measurement data associated with the designated assets. The user information may comprise, for example, context and goal information that may be used to refine and focus the mission plan. In an example, the user information may be acquired through questions and/or queries sent to the user interface. A request may then be generated for requesting the measurement data or other information to implement the mission plan.

At 704, the need for a data acquisition plan, based on the mission plan, may be evaluated. Initially, existing database information 701 may be evaluated to determine whether measurement data for any of the assets indicated in the mission plan already exists in the database information 701. A query for the measurement data may be sent to the databases, which may include historical databases, domain knowledge, and/or rules associated with the mission plan and/or any of the designated assets.

If any of the measurement data associated with the designated assets cannot be retrieved from the existing database information, then the data acquisition plan may be generated at 706 based on the overall mission plan. The data acquisition plan may utilize at least some of the measurement data available from the existing database information. The measurement data received from the existing database information 701 and may be incorporated into the data acquisition plan. The measurement data may comprise sensor data associated with the designated assets of the mission plan. For example, the sensor data may include resistance measurements, image data, or acoustic data of the designated assets. A request for data acquisition based upon the data acquisition plan may be sent at 708 and the data may be acquired at 710.

After the data acquisition at 710 is complete, the acquired data can be added to the context information provided at 702 and the process may return to 704 to again evaluate whether additional measurement data of the designated assets is available from the existing database information 701. The mission plan may also be changed or updated at 702. If needed, another query for measurement data may be sent to the databases. If the measurement data associated with the designated assets cannot be retrieved, another data acquisition plan may be generated at 706 to obtain any missing or additional measurement data associated with the designated assets in the mission plan. This data acquisition cycle may be repeated as needed until the mission plan is fully executed.

After obtaining all of the necessary measurement data associated with the designated assets, the measurement data may be processed at 712 to determine one or more parameters associated with each asset and then provide an output (e.g., a report or notification) at 714 of one or more parameters associated with each asset. For example, the output may include asset-level summaries based on the processed measurement data (e.g., the one or more parameters associated with each asset) which may also include graphs associated with each asset's measurement data. The measurement data and the asset parameters may be stored in the existing database information 701 for subsequent access and use in the evaluations of further mission plans.

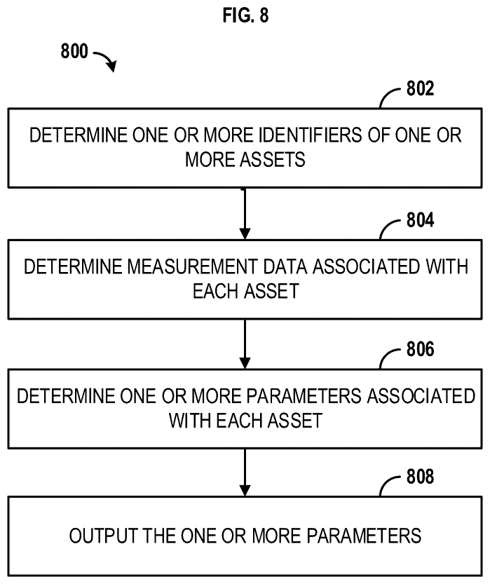

FIG. 8 shows a flowchart of an example method 800 for obtaining and processing asset measurement data. Method 800 may be implemented by either the user device 102 or the computing device 104, or a combination of the devices. At step 802, one or more identifiers may be determined based on one or more assets designated in a mission plan. For example, the one or more assets may comprise one or more wooden structures. For example, a mission plan may be created indicating specific assets for which to receive measurement data. In an example, the mission plan may comprise data indicative of an identification of the measurement data to be collected for each asset of the one or more assets, an order for determining (e.g., obtaining) the measurement data of each asset, and one or more criteria for processing the measurement data. The order for determining (e.g., obtaining) the measurement data may be based on a priority associated with each asset. The one or more criteria may comprise one or more of one or more parameters to be determined from the measurement data, one or more algorithms for analyzing the measurement data, or one or more thresholds associated with the measurement data. For example, the one or more thresholds may be associated with one or more pass/fail thresholds associated with the measurement data. Each asset may be associated with an identifier, wherein the measurement data obtained for each asset may be stored according to the associated asset identifier. For example, the one or more identifiers may be determined based on the mission plan associated with the one or more assets.

At step 804, the measurement data associated with each of the designated assets may be determined. For example, the measurement data may be received from one or more sensor devices. The one or more sensor devices may comprise one or more of a resistance sensor-enabled drill, an imaging device, a sampling device, or an acoustic sensor. In an example, the sensor device may be hand-held, affixed to robotic device or aerial vehicle, or deployed into the field near or on the asset(s) of interest. For example, the measurement data may be received from a server, wherein the server may be configured to receive the measurement data from the one or more sensor devices. The measurement data may be associated with an identifier of the asset from which the measurement data was received. For example, the measurement data may be encoded with metadata (i.e., asset identifier) to support further asset association and data processing. For example, large volumes of resistance graphs of each asset may be generated, wherein the graphs may be associated with the asset records and encoded with the metadata (i.e., asset identifier) to support further asset association. In an example, a progress of the mission plan may be tracked based on remaining assets of the one or more assets that need measurement data.

At step 806, one or more parameters associated with each asset of the one or more assets may be determined based on the measurement data. For example, the measurement data of each asset may be processed to determine the one or more parameters associated with each asset. The one or more parameters may comprise information indicative of one or more of a structural integrity of each asset, potential areas of internal decay of each asset, potential areas of surface decay of each asset, a thickness of each asset, a strength value of each asset, a density value of each asset, a level of resistance to penetration of each asset, or a remaining wall thickness of each asset. In an example, data processing algorithms may be used to generate asset-level summaries based on the measurement data. For example, multiple measurements may be combined together into asset-level summary assessments, and additional quality assurance checks may be performed to determine overall inconsistencies in each asset individually or one or more groups of assets. The measurement data and/or the one or more parameters may be further processed to further format and summarize the measurement data for further review and auditing of the measurement data. In an example, the server may be configure to evaluate, filter, and aggregate the received measurement data according to each identifier of the one or more identifiers. For example, the server may be configured to process the measurement data of each asset to determine the one or more parameters associated with each asset. In an example, the measurement data may be stored in one or more of a native format or a query-able format. For example, the measurement data may be stored in a query-able format in a database to enable quick access of measurement data associated with a specific asset.

At step 808, the one or more parameters, and/or the measurement data, associated with each asset may be output. For example, the one or more parameters, and/or the measurement data, associated with each asset may be output for display to the user. For example, the data (e.g., one or more parameters and measurement data) may be presented in a side-by-side manner for enabling an efficient means of comparing the aggregated data/results. In an example, tools may be used to support the visualization of aggregate results of the measurement data and/or the one or more parameters. In an example, a notification may be output based on the one or more parameters. For example, it may be determined that one or more parameters of each asset satisfy a threshold. In an example, the one or more parameters satisfying the threshold may indicate that the one or more parameters do not meet one or more criteria, and thus, indicating that one or more assets need to be replaced, repaired, or require additional measurement data. The notification may be output based on the one or more parameters satisfying the threshold. For example, the notification may include at least one of a recommendation to replace at least one asset of the one or more assets, a recommendation to repair at least one asset of the one or more assets, or an indication that additional data is needed for at least one asset. In an example, the one or more parameters may be aggregated for each asset of the one or more assets. As an example, the aggregated one or more parameters may be output for display to a user. As an example, the aggregated one or more parameters may be sent to a server for further processing.

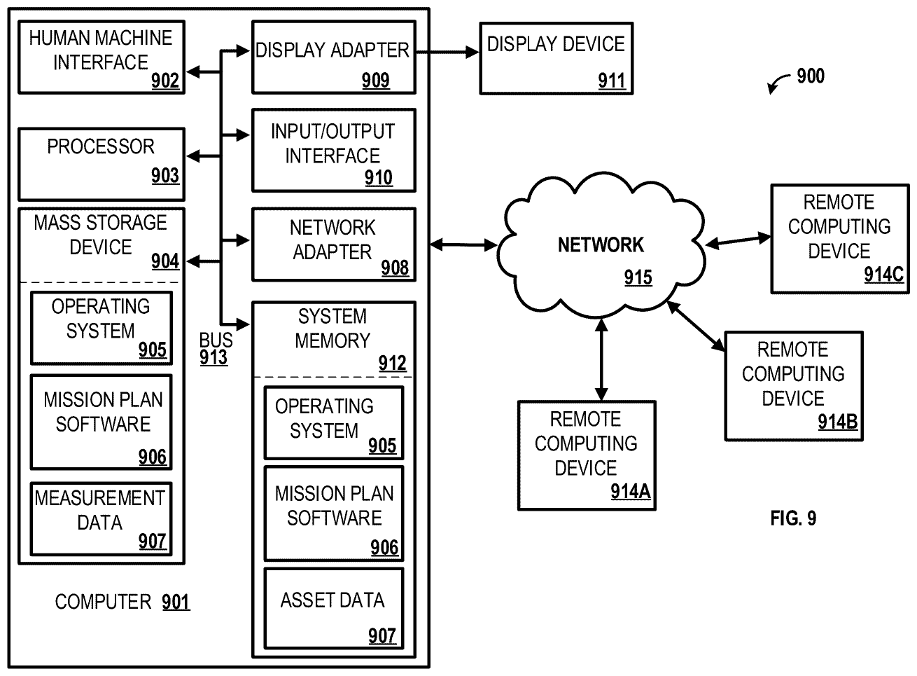

The methods and systems may be implemented on a computer 901 as shown in FIG. 9 and described below. For example, the user device 102, the computing device 104, and/or the sensor devices 116A-116D of FIG. 1 may be a computer 901 as illustrated in FIG. 9. Similarly, the methods and systems disclosed may utilize one or more computers to perform one or more functions in one or more locations. FIG. 9 shows a block diagram of an example operating environment 900 for performing the disclosed methods. Operating environment 900 is an example of an operating environment and is not intended to suggest any limitation as to the scope of use or functionality of operating environment architecture. Operating environment 900 should not be interpreted as having any dependency or requirement relating to any one or combination of components of the operating environment 900.

The present methods and systems can be operational with numerous other general purpose or special purpose computing system environments or configurations. Examples of well-known computing systems, environments, and/or configurations that can be suitable for use with the systems and methods may comprise, but are not limited to, personal computers, server computers, laptop devices, and multiprocessor systems. Additional examples may comprise set top boxes, programmable consumer electronics, network PCs, minicomputers, mainframe computers, distributed computing environments that comprise any of the above systems or devices, and the like.

The processing of the disclosed methods and systems may be performed by software components. The disclosed systems and methods may be described in the general context of computer-executable instructions, such as program modules, being executed by one or more computers or other devices. Generally, program modules may comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media such as memory storage devices.

Further, one skilled in the art will appreciate that the systems and methods disclosed herein can be implemented via a general-purpose computing device in the form of a computer 901. The computer 901 may comprise one or more components, such as one or more processors 903, a system memory 912, and a bus 913 that couples various components of the computer 901 comprising the one or more processors 903 to the system memory 912. The system can utilize parallel computing.

The bus 913 may comprise one or more of several possible types of bus structures, such as a memory bus, memory controller, a peripheral bus, an accelerated graphics port, or local bus using any of a variety of bus architectures. In an example, such architectures may comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 913, and all buses specified in this description can also be implemented over a wired or wireless network connection and one or more of the components of the computer 901, such as the one or more processors 903, a mass storage device 904, an operating system 905, mission plan software 906, measurement data 907, a network adapter 908, the system memory 912, an Input/Output Interface 910, a display adapter 909, a display device 911, and a human machine interface 902, can be contained within one or more remote computing devices 914A-914C at physically separate locations, connected through buses of this form, in effect implementing a fully distributed system.

The computer 901 may comprise a variety of computer readable media. For example, readable media may be any available media that is accessible by the computer 901 and may comprise, for example, both volatile and non-volatile media, removable and non-removable media. The system memory 912 may comprise computer readable media in the form of volatile memory, such as random access memory (RAM), and/or non-volatile memory, such as read only memory (ROM). The system memory 912 typically may comprise data such as the measurement data 907 and/or program modules such as the operating system 905 and the mission plan software 906 that are accessible to and/or are operated on by the one or more processors 903.

In an example, the computer 901 may comprise other removable/non-removable, volatile/non-volatile computer storage media. The mass storage device 904 can provide non-volatile storage of computer code, computer readable instructions, data structures, program modules, and other data for the computer 901. For example, the mass storage device 904 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

In an example, any number of program modules can be stored on the mass storage device 904, such as, for example, the operating system 905 and the mission plan software 906. One or more of the operating system 905 and the mission plan software 906 (or some combination thereof) may comprise elements of the programming and the mission plan software 906. As an example, the measurement data 907 may be stored on the mass storage device 904. As an example, the measurement data 907 may be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple locations within the network 915.

In an example, the user can enter commands and information into the computer 901 via an input device. For example the input device may comprise a keyboard, pointing device (e.g., a computer mouse, remote control), a microphone, a joystick, a scanner, tactile input devices such as gloves, and other body coverings, motion sensor, and the like These and other input devices may be connected to the one or more processors 903 via the human machine interface 902 that is coupled to the bus 913, but may be connected by other interface and bus structures, such as a parallel port, game port, an IEEE 1394 Port (also known as a Firewire port), a serial port, a network adapter 908, and/or a universal serial bus (USB).

In an example, the display device 911 may be connected to the bus 913 via an interface, such as the display adapter 909. The computer 901 may have more than one display adapter 909 and the computer 901 may have more than one display device 911. For example, the display device 911 may be a monitor, an LCD (Liquid Crystal Display), a light emitting diode (LED) display, a television, a smart lens, a smart glass, and/or a projector. In addition to the display device 911, other output peripheral devices may comprise components such as speakers and a printer which may be connected to the computer 901 via an Input/Output Interface 910. Any step and/or result of the methods can be output in any form to an output device. Such output can be any form of visual representation, comprising, but not limited to, textual, graphical, animation, audio, tactile, and the like. The display device 911 and the computer 901 can be part of one device, or separate devices.

The computer 901 can operate in a networked environment using logical connections to one or more remote computing devices 914A-914C. For example, a remote computing device 914A-914C may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computer 901 and a remote computing device 914A-914C can be made via a network 915, such as a local area network (LAN) and/or a general wide area network (WAN). Such network connections can be through the network adapter 908. The network adapter 908 can be implemented in both wired and wireless environments. Such networking environments are conventional and commonplace in dwellings, offices, enterprise-wide computer networks, intranets, and the Internet.

For purposes of illustration, application programs and other executable program components such as the operating system 905 are illustrated herein as discrete blocks, although it is recognized that such programs and components can reside at various times in different storage components of the computing device 901, and are executed by the one or more processors 903 of the computer 901. An implementation of the mission plan software 906 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. For example, computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques such as machine learning and iterative learning. Examples of such techniques comprise, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, such as: matters of logic with respect to arrangement of steps or operational flow; plain meaning derived from grammatical organization or punctuation; the number or type of embodiments described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
determining, by a computing device, one or more identifiers associated with one or more assets;
determining, based on the one or more identifiers, measurement data associated with each asset of the one or more assets;
determining, based on the measurement data, one or more parameters associated with each asset of the one or more assets; and
outputting the one or more parameters associated with each asset of the one or more assets.

2. The method of claim 1, wherein the one or more assets comprise one or more wooden structures.

3. The method of claim 1, wherein determining the one or more identifiers associated with the one or more assets comprises determining, based on a mission plan associated with the one or more assets, the one or more identifiers associated with the one or more assets, wherein the mission plan comprises data indicative of an identification of the measurement data to be collected for each asset of the one or more assets, an order for determining the measurement data of each asset, and one or more criteria for processing the measurement data.

4. The method of claim 3, wherein the order for determining the measurement data of each asset of the one or more assets is based on a priority of each asset of the one or more assets, and wherein the one or more criteria comprises one or more of one or more parameters to be determined from the measurement data, one or more algorithms for analyzing the measurement data, or one or more thresholds associated with the measurement data.

5. The method of claim 1, wherein determining the measurement data associated with each asset of the one or more assets comprises receiving the measurement data from one or more of a second computing device or one or more sensor devices, wherein the one or more sensor devices comprise one or more of a resistance sensor-enabled drill, an imaging device, a sampling device, an acoustic sensor, or any combination thereof.

6. The method of claim 1, wherein the measurement data is evaluated, filtered, and aggregated according to each identifier of the one or more identifiers.

7. The method of claim 1, wherein the one or more parameters comprise information indicative of one or more of a structural integrity of each asset, potential areas of internal decay of each asset, potential areas of surface decay of each asset, a thickness of each asset, a strength value of each asset, a density value of each asset, a level of resistance to penetration of each asset, or a remaining wall thickness of each asset.

8. The method of claim 1, wherein outputting the one or more parameters associated with each asset of the one or more assets comprises:
aggregating one or more parameters for each asset of the one or more assets; and
causing an output of the aggregated one or more parameters.

9. The method of claim 1, further comprising outputting the measurement data, wherein the measurement data is output based on an aggregation of the measurement data according to each asset of the one or more assets.

10. The method of claim 1, further comprising:
determining if one or more parameters of each asset satisfies a threshold; and
outputting, based on the one or more parameters of each asset satisfying the threshold, one or more notifications,
wherein the one or more notifications comprise at least one of a recommendation to replace at least one asset of the one or more assets, a recommendation to repair at least one asset of the one or more assets, or an indication that additional measurement data is needed for at least one asset.

11. A system comprising:
one or more sensor devices, wherein the one or more sensor devices are configured to:
determine measurement data associated with one or more assets, wherein each asset of the one or more assets is associated with an identifier of one or more identifiers;
associate the measurement data from each asset with each identifier;
send the measurement data associated with each identifier of the one or more identifiers; and
a computing device in communication with the one or more sensor devices, wherein the computing device is configured to:
determine one or more identifiers associated with the one or more assets;
receive, based on the determined one or more identifiers, the measurement data associated with the one or more assets;
determine, based on the measurement data, one or more parameters associated with each asset of the one or more assets; and
output the one or more parameters associated with each asset of the one or more assets.

12. The system of claim 11, wherein the one or more sensor devices comprise one or more of a resistance sensor-enabled drill, an imaging device, a sampling device, an acoustic sensor, or any combination thereof, and wherein the one or more assets comprise one or more wooden structures.

13. The system of claim 11, wherein the computing device is configured to determine the one or more identifiers associated with the one or more assets based on a mission plan associated with the one or more assets, wherein the mission plan comprises data indicative of an identification of the measurement data to be collected for each asset of the one or more assets, an order for determining the measurement data of each asset, and one or more criteria for processing the measurement data.

14. The system of claim 13, wherein the order for determining the measurement data of each asset of the one or more assets is based on a priority of each asset of the one or more assets, and wherein the one or more criteria comprises one or more of one or more parameters to be determined from the measurement data, one or more algorithms for analyzing the measurement data, or one or more thresholds associated with the measurement data.

15. The system of claim 11, wherein the computing device is further configured to:
receive the measurement data from the one or more sensor devices; and
store the measurement data in one or more of a native format or a query-able format.

16. The method of claim 11, wherein the computing device is further configured to evaluate, filter, and aggregate the measurement data according to each identifier of the one or more identifiers.

17. The system of claim 11, wherein the one or more parameters comprise information indicative of one or more of a structural integrity of each asset, potential areas of internal decay of each asset, potential areas of surface decay of each asset, a thickness of each asset, a strength value of each asset, a density value of each asset, a level of resistance to penetration of each asset, or a remaining wall thickness of each asset.

18. The system of claim 11, wherein the computing device configured to output the one or more parameters associated with each asset of the one or more assets, the computing device configured to:
aggregate one or more parameters for each asset of the one or more assets; and
output the aggregated one or more parameters.

19. The system of claim 11, wherein the computing device is further configured to output the measurement data based on an aggregation of the measurement data according to each asset of the one or more assets.

20. The system of claim 11, wherein the computing device is further configured to:
determine if one or more parameters of each asset satisfies a threshold; and
output, based on the one or more parameters of each asset satisfying the threshold, one or more notifications,
wherein the notification comprises at least one of a recommendation to replace at least one asset of the one or more assets, a recommendation to repair at least one asset of the one or more assets, or an indication that additional measurement data is needed for at least one asset.
